(19) United States
(12) Patent Application Publication
(10) Pub. No.: US 2011/0157911 A1
(43) Pub. Date: Jun. 30, 2011

(54) Light Pipe Illumination System

(75) Inventor: SAMIR MEZOUARI, BASILDON (GB)

(73) Assignee: VISTEON GLOBAL TECHNOLOGIES, INC., Van Buren Township, MI (US)

(21) Appl. No.: 12/791,158

(22) Filed: Jun. 1, 2010

(30) Foreign Application Priority Data
Jul. 23, 2009 (GB) 0912875.2

(51) Int. Cl. F21V 8/00

(52) U.S. Cl. 362/559

(57) ABSTRACT

A light pipe for illuminating a vehicle display having an arcuate tubular member made of an optically transmissive material with a first surface portion having a first radius of curvature diametrically opposite and a second surface portion having a second radius greater than the first radius. A first surface portion having a first series of notches spaced along the length of the first surface portion defines first regions of smooth surface between the notches. A second series of notches spaced along the length of the second surface portion defines second regions of smooth surface between the notches. The first and second series of notches are offset such that a notch in the first series lies diametrically opposite to a second region of smooth surface, so that light conveyed by the light pipe is deflected by each notch through said smooth surfaces and out of the light pipe.

### BACKGROUND OF THE INVENTION

1. Technical Field

The present invention relates to a light pipe for illuminating a display, and in particular to a light pipe for illuminating a vehicle display having various gauge sizes.

2. Discussion

Instruments for displaying information on a vehicle display are usually located on the dashboard of an automotive vehicle, and require some form of illumination to allow the driver to read the information when it is dark. An instrument usually comprises an information surface in a housing having a transparent cover for protection of the instrument. The information surface usually has symbols indicating a scale such as graphics, numbers or a dial, and a pointer for indicating a point within the scale, or may comprise a liquid crystal display suitable for displaying numeric information. The information surface may also include features such as rings defining the perimeter of a particular instrument or gauge. The instrument is generally mounted on a printed circuit board (PCB) which is connected to sensors (directly or indirectly via a network) which monitor certain engine conditions such as speed, temperature and fuel level to name but a few. Conventionally instruments are mounted together to form an instrument cluster.

In general one of two types of illumination is used, either front lighting or back lighting. Front lighting refers to illumination from the viewing side of the information surface which reflects off the information surface. The light need not be perpendicular to the information surface, hence this term includes side lighting, where the light is reflected from the information surface. The information is printed so that the light reflecting from the symbols is in contrast to the light reflecting from a background, for example the symbols may be black and the background may be white, which is sometimes called positive mode, or the symbols may be white and the background may be black and in this case referred to as negative mode. Back lighting refers to illumination of the information surface from the side opposite to the viewing side of the instrument. In this case the information surface contains opaque or semi opaque portions so that the light passing through the information surface renders the symbols visible.

Front or back lighting may be achieved either by providing illumination directly from a light source (which may include the use of reflective surfaces), or indirectly from a light source which is coupled to a light pipe which directs the light from the light source to the required illumination point.

One method of providing lighting to a display is known from U.S. Publication No 2005/0285256 A1, which discloses the use of a light guide to illuminate a segment of an annular region of a dial. This annular region includes a reflective surface and the light emitted by the light guide is reflected by the reflective surface towards the information surface of the display.

Advances in motor vehicle technology and the desire to convey larger amounts of information to a driver of a vehicle results in vehicle display units that are becoming crowded with various dials and displays showing many different types of information. To prevent the display unit becoming too cluttered it is common to use compound dials, that is the dials include more than one scale displaying values of different vehicle conditions, or dials that include a region displaying indicia such as warning symbols.

It is important that all of this information is clearly displayed and illuminated in such a way that it is clearly visible to a driver at all times.

Furthermore, as customers become more sophisticated in their requirements, it becomes important to provide lighting for vehicle instruments which is distinctive, aesthetically pleasing and cost effective to produce.

It is, therefore, an object of the present invention to provide an improved means of illuminating a display.

### SUMMARY OF THE INVENTION

The invention provides a light pipe for illuminating a display area, in which the light pipe comprises: an arcuate tubular member made of an optically transmissive material; a first surface portion of the tubular member having a first radius of curvature; a second surface portion of the tubular member having a second radius of curvature greater than the first radius of curvature and being diametrically opposite the first surface portion; the first surface portion having a first series of notches spaced along the length of the first surface portion and defining first regions of smooth surface between the notches; and the second surface portion having a second series of notches spaced along the length of the second surface portion and defining second regions of smooth surface between the notches; wherein, the first and second series of notches are offset from each other such that a notch in the first series lies diametrically opposite to a second region of smooth surface of the second surface portion and the notches in both the first and second series are V-shaped and are oriented such that a line bisecting a notch passes through an apex of the notch and said diametrically opposite second region of smooth surface so that light conveyed by the light pipe is deflected by each notch through said smooth surfaces and out of the light pipe.

There is also provided a light pipe illumination system, comprising a light pipe and a source of illumination, in which the light pipe is according to the first aspect of the invention and the light pipe further comprises a first end arranged to receive light from the source of illumination.

Preferably the notches are oriented so that the line bisecting a notch and passing through the apex of the notch lies perpendicular to a longitudinal axis of the light pipe at that location. This improves the efficiency of the light pipe so that most light is quickly deflected out of the length of the light pipe.

To further improve the efficiency of the light pipe and to ensure that the light emitted is evenly distributed along the length of the light pipe, it is advantageous to arrange the notches such that a notch in the first series lies midway between two notches in the second series.

It may be preferable that the first series of notches comprises one more notch than the second series of notches so that the intensity of illumination of a surface on either side of the light pipe is substantially the same.

It may also be desirable to include an un-notched portion at a second end of the light pipe towards which illumination received at the first end is conveyed within the light pipe. Typically the length of the un-notched portion is greater than the distance between adjacent notches in a series. As this portion of the light pipe is un-notched, light entering the un-notched portion can only exit the second end of the un-notched portion. This is useful when the un-notched portion is used to direct some of the light in the light pipe to a more remote region of the display area.

The light pipe may be uniformly curved in the region of the notches and optionally also the un-notched portion. It may be desirable to design the light pipe so that the radius of curvature of the un-notched portion is not equal to the radius of curvature of the rest of the light pipe.

Also according to the invention there is provided an instrument for a vehicle comprising a light pipe illumination system according to the invention and an information surface, wherein the light pipe is arranged to illuminate the information surface.

The instrument may further comprise a reflective portion and the light pipe may be disposed between the information surface and the reflective portion, such that light escaping from said light pipe is reflected by the reflective portion toward the information surface to provide a back-lit display.

If the information surface comprises two concentric scales, the light pipe may be arranged such that light emitted from the first surface portion illuminates a first inner scale and light emitted from the second surface portion illuminates a second outer scale. When the light pipe includes an un-notched end portion, the light pipe may be arranged such that light emitted from the end of the un-notched portion illuminates an additional region of the information surface remote from the concentric scales.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a plan view of a first exemplary light pipe according to the present invention;

FIG. 2 is a perspective view of the light pipe of FIG. 1;

FIG. 3 is an illustration of the path that light takes through and from a second exemplary light pipe of the present invention;

FIG. 4 is a magnified view of region A of FIG. 3;

FIG. 5 is a magnified view of region B of FIG. 3;

FIG. 6 is a plan view of a third exemplary light pipe according to the present invention;

FIG. 7 is a rear view of part of an instrument display panel showing an exemplary light pipe used to illuminate a dial;

FIG. 8 is an illustration of light escaping from the light pipe of FIG. 7 and being reflected towards a display face; and

FIG. 9 is a perspective view of a display incorporating a light pipe according to an embodiment of the present invention.

### DETAILED DESCRIPTION OF THE PREFERRED EMBODIMENT

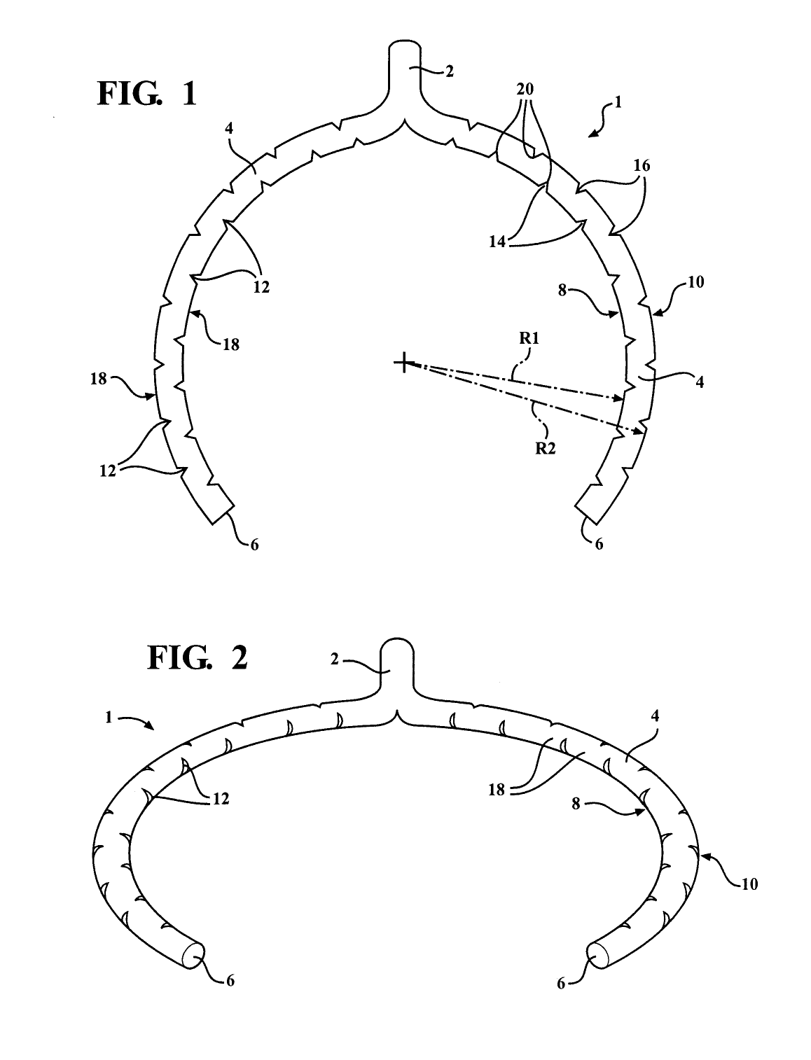

FIG. 1 shows a plan view of a light guide or light pipe 1 according to a first preferred embodiment of the invention. The light pipe 1 generally consists of a solid tube having a diameter of between 2 and 6 mm made of a light transmissive material, in this example polycarbonate or polymethyl methacrylate (PMMA).

The light pipe 1 has an inlet stem 2 and two arcuate branches 4 terminating in branch ends 6. In this example, the two branches 4 are identical and the junction between the inlet stem 2 and the branches 4 is substantially symmetrical such that the light pipe 1 is symmetrical about a plane containing the axis of the inlet stem 2. Each arcuate branch 4 of the light pipe 1 has a radially inner 8 and a radially outer 10 surface, having radii of curvature of R1 and R2 respectively.

A light source (not shown) is arranged to emit light into the end of the stem 2. Typically the light pipe 1 will be coupled to a light source such as a light emitting diode (LED) source. The light emitted by the light source is confined and transported efficiently within the material of the light pipe 1 by internal reflections.

Grooves or notches 12 are present in both the radially inner and outer surfaces 8, 10 of the branches 4. A first series of notches 14 is cut in the inner surface 8 and a second series of notches 16 is cut in the outer surface 10. In each series of notches 14, 16, the notches 12 are spaced equidistantly along the surface with lengths of smooth surface 18 between the notches. As shown in FIG. 1, the first and second series 14, 16 are offset from one another by half a length along the axis of the light pipe branch 4. In other words, the notches 12 in the inner and outer surfaces 8, 10 are offset from each other such that a notch 12 in the inner surface 8 lies midway between two notches 12 in the outer surface 10.

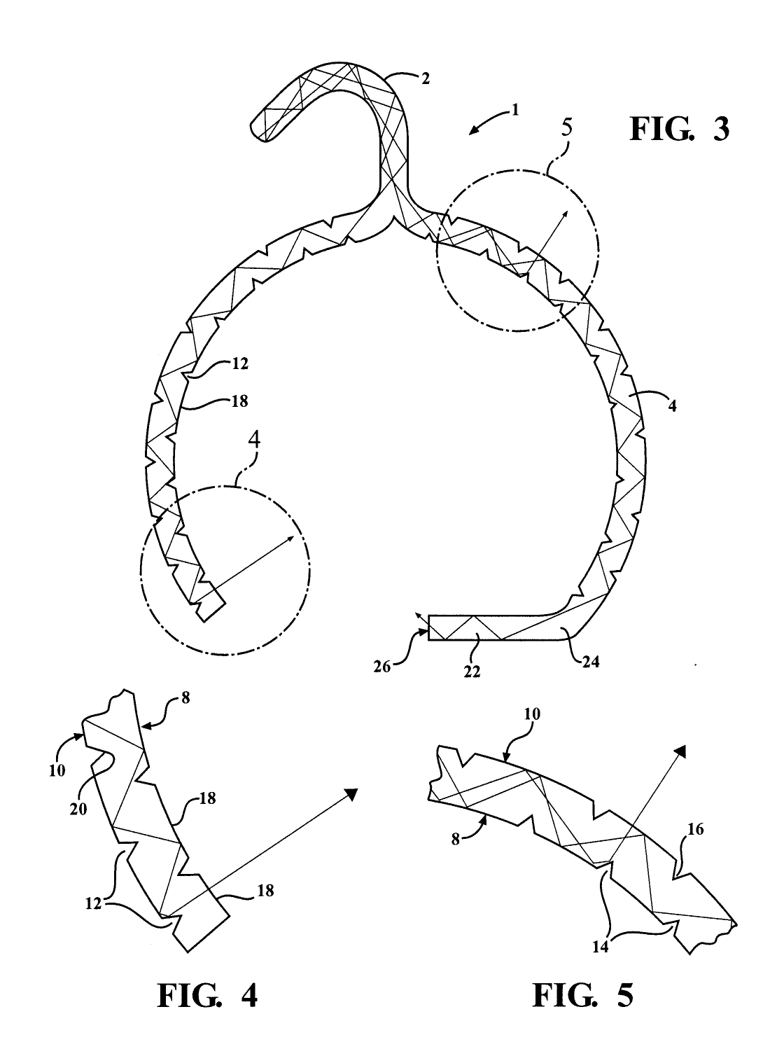

The notches 12 in both the inner and outer surfaces 8, 10 are V-shaped and are created to cause the confined light to escape from the light pipe 1, as illustrated in FIG. 3. The notches 12 are oriented such that a line bisecting a notch 12 and passing through the apex 20 of the notch 12 is perpendicular to the axis of the tube at that location.

The notches 12 are cut progressively deeper moving along the branch 4 of the light pipe 1 toward the branch end 6. In this way, if a first notch is in the inner surface 8, a second notch is in the outer surface 10 and a third notch is again in the inner surface 8, then the third notch will be cut deeper than the second notch, which will, in turn, be deeper than the first notch. This arrangement compensates for the progressive loss of light down the length of the light pipe so that substantially the same amount of light escapes from the light pipe 1 along the full length of the branch 4 to provide even illumination of the adjacent area.

As light travels along each of the branches 4 by total internal reflection, a light wave will at some point be deflected by a notch 12. All the notches are angled so that the light wave will be deflected through an angle such that the light is able to escape the light pipe 1 through the smooth surface 18 opposite the notch 12. This process is most clearly illustrated in FIGS. 4 and 5. When the light strikes a notch 12 in the second series 16 it is deflected so that it passes though a smooth portion 18 of the inner surface 8. Similarly, light impinging a notch 12 in the first series 14 is deflected so that it passes though a smooth portion 18 of the outer surface 10.

The arcuate shape of the branches 4 of the light pipe 1 means that the light rays escaping from the inner surface 8 are converging while the light rays escaping from the outer surface 10 are diverging, and in addition, because R2 is greater than R1, the length of the outer surface 10 is longer than the inner surface 8. The light falling on an area adjacent the inner surface 8 is therefore likely to be more intense than the light falling on an area adjacent the outer surface 10 of the light pipe 1. To more evenly distribute the light between inner and outer surfaces 8, 10, in a preferred embodiment, the first series 14 contains one more notch 12 than the second series 16. This means that a greater proportion of the light contained within the light pipe 1 is emitted from the outer surface 10 than the inner surface 8, and the resultant light intensities are more evenly distributed both sides of the light pipe 1.

It will be appreciated however that design considerations may mean that it is desirable to have a greater intensity of light emitted from one or other of the radially inner or outer surfaces 8, 10, and this may be achieved by tailoring the number of notches 12 accordingly. However, a notch 12 on one side of the light pipe 1 must always be diametrically opposite a smooth surface 18 on the other side.

As illustrated in FIG. 3, the light pipe 1 may include an un-notched portion 22 extending from the end 6 of one of the branches 4, as shown in FIG. 3. In this example, the un-notched portion or finger 22 extends at an angle from the branch 4 such that the radius of curvature of the join between the branch 4 and the finger 22 is substantially smaller than the radius of curvature R1 of the branch 4.

Light that is not deflected by a notch 12 reaches the end of the branch 4 and enters the finger 22 at its first end 24. Because the finger 22 does not include any notches 12 along its length, the light is contained within the finger 22 and is only emitted from the second, free end 26. In this way the finger 22 allows light to be channeled and directed to a particular region. As the majority of the light emitted from the finger 22 is substantially parallel to the axis of the finger 22 or is only diverging within a limited angle, the light emitted from the free end 26 of the finger 22 illuminates an area more evenly than the converging or diverging light emitted from the inner or outer surfaces 8, 10 of the branches 4.

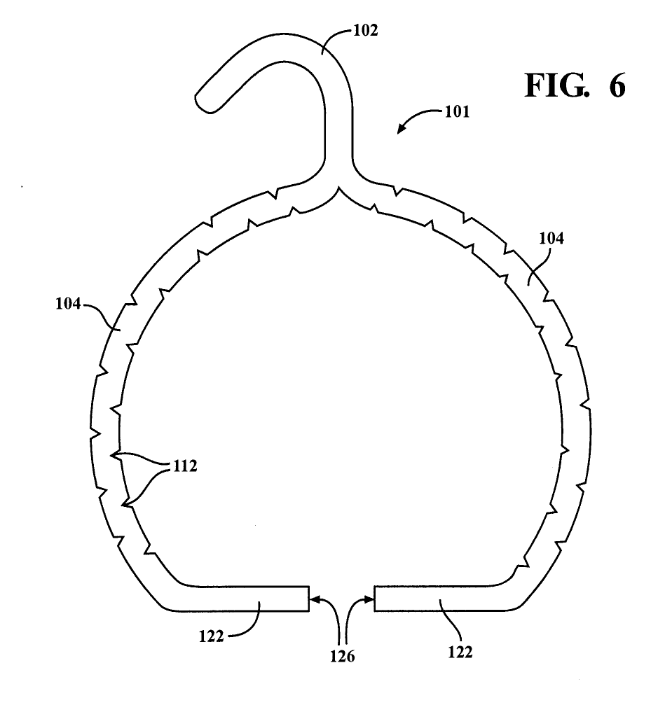

FIG. 6 shows another embodiment of the invention in which similar features to those described previously have been incremented by 100. In this example, both branches 104 include un-notched end fingers 122. This arrangement could be used to illuminate an LCD or counter display, for example a milometer, located between the opposing free ends 126 of the fingers 122.

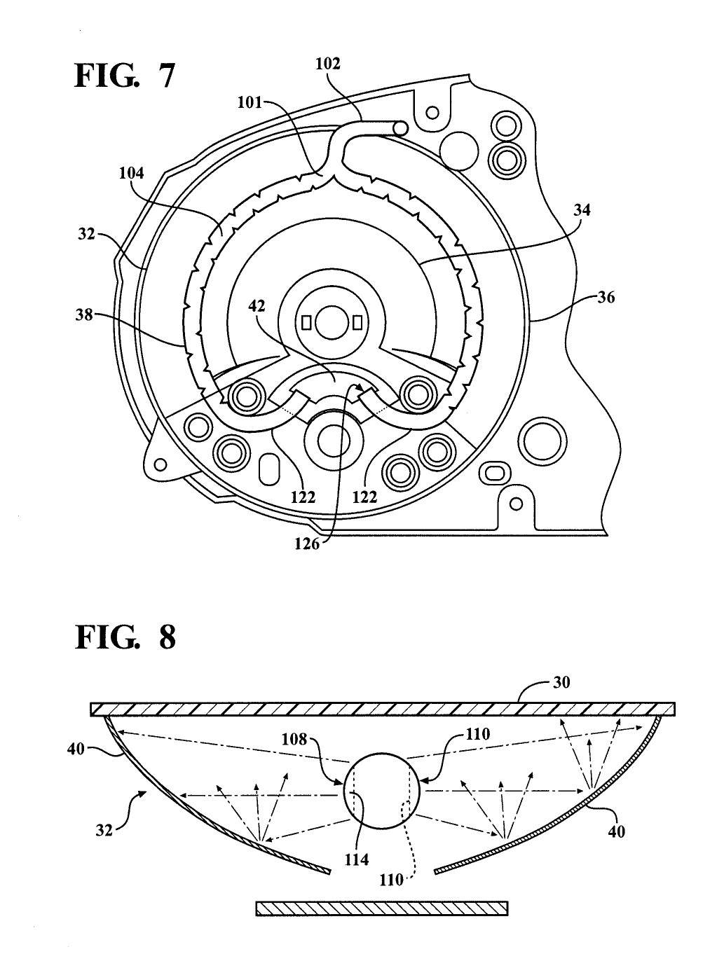

FIGS. 7 and 8 illustrate an embodiment of the light pipe 101 similar to that shown in FIG. 6 placed behind an information surface 30 of a display 32. The light pipe 101 is used to illuminate both inner 34 and outer 36 regions of a wide aperture dial 38, which is difficult to illuminate effectively and evenly using conventional lighting arrangements. The wide aperture dial 38 may be, for example, a speedometer indicating vehicle speed in miles-per-hour (mph) on an outer scale and vehicle speed in kilometers-per-hour (kph) on an inner scale. As shown in FIG. 8, the light emitted from the first and second series of notches 114, 116 is directed towards a curved reflective surface 40 mounted behind the information surface 30 of the dial 38. The reflective surface 40 is made of an opaque and diffusing material such as Acrylonitrile Butadiene Styrene (ABS), and the radius of curvature of the reflective surface 40 is chosen to reflect the light evenly over the width of the wide aperture dial 38. In this example, un-notched fingers 122 extend from the end of both branches 104 of the light pipe 101 and are arranged to direct light to a second arcuate gauge 42 adjacent the main dial 38. This second gauge 42 may be used to indicate a vehicle's fuel level for example. Any light that is not emitted along the length of the branches 104 in the main dial 38 is conveyed within the un-notched fingers 122, which in this example are curved in towards the centre of the light pipe 101. The light is emitted from the free ends 126 of the fingers 122 to evenly illuminate the second gauge 42.

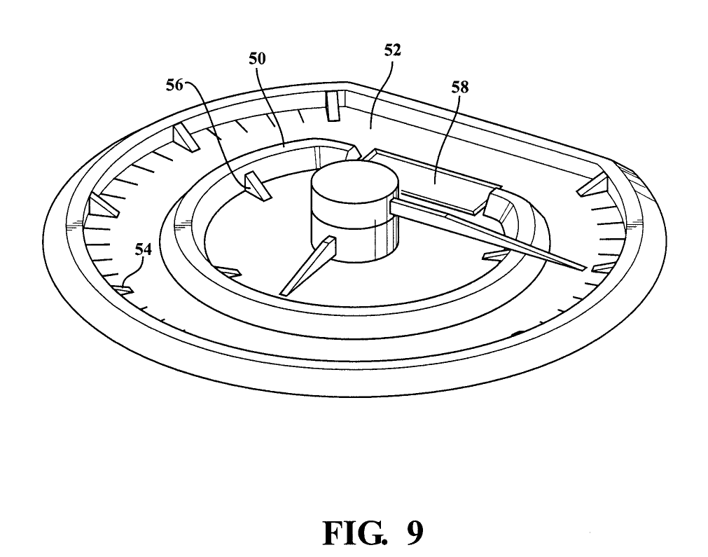

FIG. 9 shows the invention in which the light pipe (not shown) is contained within a raised ring 50 on the surface of a dial 52. In this example, the dial 52 comprises two scales 54, 56 for indicating two different vehicle conditions. Light emitted from the outer surface of the light pipe illuminates the outer scale 54 and the light emitted from the inner surface of the light pipe illuminates the inner scale 56. In this arrangement it may be desirable to have a different intensity of illumination for the inner and outer scales 56, 54 which can be achieved by varying the number of notches in the first and second series, but still maintaining an offset between the series so that a notch in the first series lies between two notches in the second series and vice versa. Additionally, un-notched fingers are used to direct light to illuminate an LCD display 58 positioned between the opposing free ends of the fingers.

In this way, the light pipe of the present invention permits tailored and effective illumination of a display cluster having various gauge sizes, for example a pair of gauges arranged concentrically. This allows more information to be displayed in a smaller area of the display while still be clearly visible to a viewer, as each of the regions are distinctly illuminated.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A light pipe for illuminating a display area, in which the light pipe comprises:
an arcuate tubular member made of an optically transmissive material;
a first surface portion of the tubular member having a first radius of curvature;
a second surface portion of the tubular member having a second radius of curvature greater than the first radius of curvature and being diametrically opposite the first surface portion;
the first surface portion having a first series of notches spaced along the length of the first surface portion and defining first regions of smooth surface between the notches; and
the second surface portion having a second series of notches spaced along the length of the second surface portion and defining second regions of smooth surface between the notches;
wherein, the first and second series of notches are offset from each other such that a notch in the first series lies diametrically opposite to a second region of smooth surface and the notches in both the first and second series are V-shaped and are oriented such that a line bisecting a notch passes through an apex of the notch and said diametrically opposite second region of smooth surface so that light conveyed by the light pipe is deflected by each notch through said smooth surfaces and out of the light pipe.

2. The light pipe of claim 1 in which said line is perpendicular to a longitudinal axis of the light pipe at that location.

3. The light pipe of claim 1 in which a notch in the first series lies midway between two notches in the second series.

4. The light pipe of claim 1 in which the first series of notches comprises one more notch than the second series of notches.

5. A light pipe illumination system for illuminating a display area comprising:
a light source;
a light pipe having a first end arranged to receive light from said light source;
an arcuate tubular member made of an optically transmissive material;
a first surface portion of the tubular member having a first radius of curvature;
a second surface portion of the tubular member having a second radius of curvature greater than the first radius of curvature and being diametrically opposite the first surface portion;
the first surface portion having a first series of notches spaced along the length of the first surface portion and defining first regions of smooth surface between the notches; and
the second surface portion having a second series of notches spaced along the length of the second surface portion and defining second regions of smooth surface between the notches;
wherein, the first and second series of notches are offset from each other such that a notch in the first series lies diametrically opposite to a second region of smooth surface and the notches in both the first and second series are V-shaped and are oriented such that a line bisecting a notch passes through an apex of the notch and said diametrically opposite second region of smooth surface so that light conveyed by the light pipe is deflected by each notch through said smooth surfaces and out of the light pipe.

6. The light pipe illumination system of claim 5 further comprising:
a second end towards which said received illumination is conveyed within the light pipe; and
an un-notched portion at the second end of the light pipe, wherein the length of the un-notched portion is greater than the distance between adjacent notches in a series, and wherein light entering the un-notched portion can only exit the second end of the light pipe.

7. The light pipe illumination system of claim 6 in which the curvature of the notched and un-notched portions of the light pipe is the same.

8. The light pipe illumination system of claim 6 in which the curvature of the notched and un-notched portions of the light pipe is different.

9. The light pipe illumination system of claim 5 further comprising an information surface and wherein said light pipe is arranged to illuminate said information surface.

10. The light pipe illumination system of claim 9 further comprising a reflective portion in which said light pipe is disposed between said information surface and said reflective portion, such that light escaping from said light pipe is reflected by the reflective portion toward said information surface.

11. The light pipe illumination system of claim 9 in which said information surface comprises two concentric scales and said light pipe is arranged such that light emitted from the first surface portion illuminates a first inner scale of said two concentric scales and wherein and light emitted from the second surface portion illuminates a second outer scale of said tow concentric scales.

12. The light pipe illumination system of claim 11 further comprising:
a second end towards which said received illumination is conveyed within the light pipe;
an un-notched portion at the second end of the light pipe, wherein the length of the un-notched portion is greater than the distance between adjacent notches in a series, and wherein light entering the un-notched portion can only exit the second end of the light pipe; and
wherein said light pipe is arranged such that light emitted from said second end of said un-notched portion illuminates an additional region of said information surface remote from said concentric scales.
